(19) United States
(12) Patent Application Publication
(10) Pub. No.: US 2013/0136005 A1
(43) Pub. Date: May 30, 2013

(54) DATA MANAGER FOR MANAGING STATION DATA OF COMMUNICATION DEVICES ON A TELECOMMUNICATIONS NETWORK

(71) Applicant: Oki Electric Industry Co., Ltd., Tokyo (JP)

(72) Inventors: Tomoyasu SUZUKI, Tokyo (JP); Kanami Hashimoto, Tokyo (JP)

(73) Assignee: Oki Electric Industry Co., Ltd., Tokyo (JP)

(21) Appl. No.: 13/658,858

(22) Filed: Oct. 24, 2012

(30) Foreign Application Priority Data
Nov. 30, 2011 (JP) 2011-262259

(51) Int. Cl. H04L 12/26

(52) U.S. Cl. 370/241

(57) ABSTRACT

The data manager manages in a station data memory information on connecting communication devices including various numbers and signal processing conditions in correspondence with state information on the state of the connecting communication devices with the information on the communication devices classified into managing groups to update the state information associated with the information on the communication devices on a managing group-by-group basis.

### BACKGROUND OF THE INVENTION

1. Field of the Invention

The present invention relates to a signal processing apparatus, and more particularly to a data manager provided in, for example, a telecommunications carrier for managing station data of connecting communication devices.

2. Description of the Background Art

Terminal devices, communication devices or the like used by subscribers may be referred to as connecting communication devices in the context. In a telecommunications carrier or the like, a signal processing apparatus for processing signals coming from connecting communication devices is adapted to manage station data. In the signal processing apparatus for processing signals with the use of station data, the station data are preferably updated every time changes occur on the connecting communication devices under its control.

As existing solutions for updating station data to be used in communication devices, there are disclosed ones in Japanese patent laid-open publication Nos. 2004-128806 and 2000-295225.

The solution disclosed in the Japanese '806 publication updates in a lump a plurality of station data definitions, each of which is a component of the station data, by means of a system of updating the station data. The Japanese '225 publication discloses a testing system for testing a communication processor provided with station data in order to attain accurate and efficient updating. In the testing system, difference data resultant from comparison between station data formed by a network administrator and the data of stations in operation are used to form a testing scenario for confirming whether or not the formed data are correct. In other words, in this system, if the result from confirmation in the formed testing scenario is satisfactory, the data of the stations in operation are then updated.

However, the solution disclosed in the Japanese '806 publication makes it possible to update plural station data in a lump whereas the updated data are immediately treated as operational data in service for communication devices without being subjected to a test process. Even using this solution, if any of the plural station data is erroneously input, station data for updating the operational data will have to be revised. Further in case of using this solution, if a dependency relationship is involved between the station data updated in a lump, the operator has to identify the station data having such a dependency relationship to then produce plural station data for correction. As described above, the solution disclosed in the Japanese '806 publication is problematic in that station data to be updated cannot be tested once and that the operator introducing himself/herself in correcting the station data to produce data for correction may induce erroneous input of the data.

The solution disclosed in the Japanese '225 publication provides means for checking the correctness of the updated station data, so that the updated station data, when tested successfully, will immediately be brought into service in a communication device. For example, to a connecting communication device refrained from being used due to a security difficulty, it is preferable to prevent a communication connection from being established. However, the solution disclosed in the Japanese '225 publication permits the station data, once determined good through the test, to be registered as effective data.

### SUMMARY OF THE INVENTION

It is an object of the present invention to provide a data manager and also a signal processing apparatus for facilitating accurate information management of communication devices.

In accordance with the invention, a data manager for managing information for use in processing a signal by a signal processing apparatus for processing signals received from communication devices comprises: a first information memory managing communication device information including numbers and signal processing conditions about the communication devices in correspondence with state information on a state of the communication devices with the communication device information classified into a plurality of managing groups; and a data updater updating the state information associated with the communication device information on a managing group-by-group basis.

Also in accordance with the present invention, a signal processing apparatus for processing signals received from communication devices comprises: a first information memory managing communication device information including numbers and signal processing conditions about the communication devices in correspondence with state information on a state of the communication devices with the communication device information classified into a plurality of managing groups; a data updater updating the state information associated with the communication device information on a managing group-by-group basis; and a signal processor using information managed in the first information memory to process signals received from the communication devices.

In an aspect of the present invention, there is provided a managing program which controls, when installed and executed on a computer, the computer to function as the data manager set forth above.

In another aspect of the invention, there is provided a signal processing program which controls, when installed and executed on a computer, the computer to function as the signal processing apparatus set forth above.

In accordance with the present invention, information on communication devices used by the signal processing apparatus in processing signals incoming from the communication devices can be managed easily and correctly.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the configuration of a telecommunications network system provided with a data manager in accordance with the present invention;

FIG. 2 is a schematic block diagram showing the configuration of a signal processing unit, to which the data manager is applied in accordance with the invention;

FIG. 3 schematically shows an example of format of a station data managing table shown in FIG. 2;

FIG. 4 schematically shows an example of format of an identification managing table shown in FIG. 2;

FIG. 5 is a flowchart useful for understanding the operational procedure for adding new information to the station data managing table in the signal processing unit shown in FIG. 2;

FIGS. 6A and 6B respectively show the starting state and the registered state of the station data managing table shown in FIG. 2;

FIG. 7 is a flowchart useful for understanding the operational procedure for adding new information to the identification managing table in the signal processing unit shown in FIG. 2;

FIGS. 8A and 8B respectively show the starting state and the registered state in the identification managing table shown in FIG. 2;

FIG. 9 is a flowchart useful for understanding the operational procedure for batch-updating the device state information on the station data managing table of the signal processing unit shown in FIG. 2;

FIGS. 10A and 10B show the batch-updated states of the station data managing table shown in FIG. 2;

FIGS. 11A and 11B show the batch-updated states of the identification managing table shown in FIG. 2;

FIG. 12 is a flowchart useful for understanding the procedure for editing the station data managing table or identification managing table shown in FIG. 2 except for adding new information; and

FIG. 13 is a flowchart useful for understanding the procedure for processing signals in the signal processing unit shown in FIG. 2.

### DESCRIPTION OF THE PREFERRED EMBODIMENT

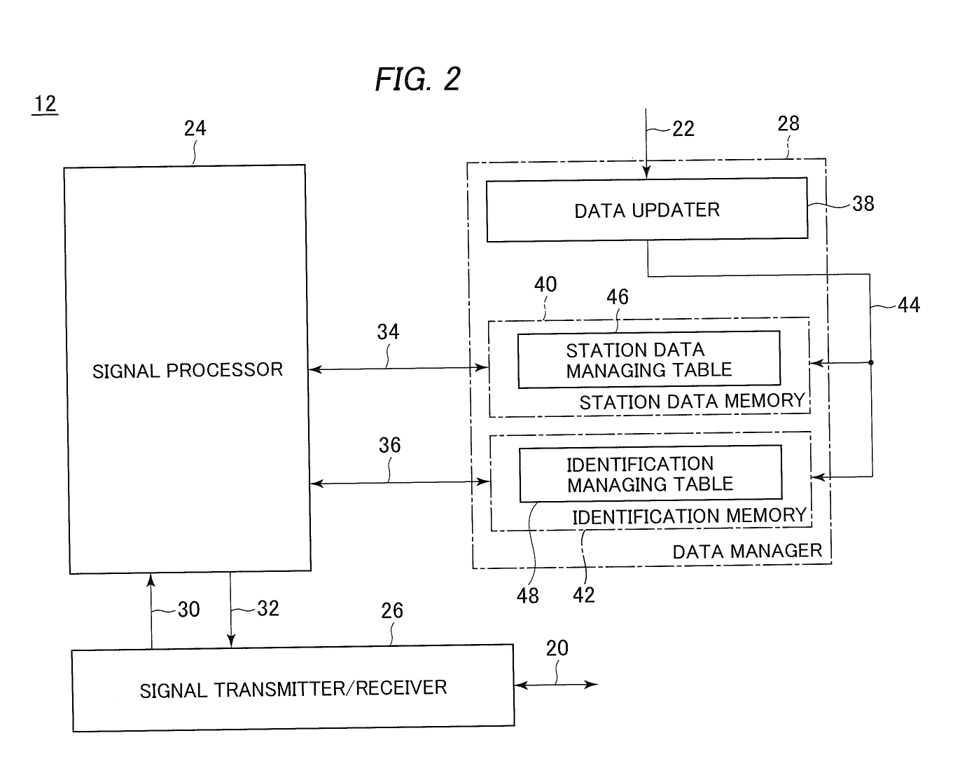

Now, a preferred embodiment of a data manager in accordance with the present invention will be described with reference to the appended drawings. With reference to FIG. 2 first, a preferred embodiment 28 of the data manager in accordance with the invention is adapted to manage information for use in processing signals by a signal processing arrangement or unit 12 for processing signals received from connecting communication devices. The data manager 28 manages, on the station data managing table 46 in a station data memory 40, information including various numbers and signal processing conditions about the connecting communication devices in correspondence with the state information on the state of the respective connecting communication devices with the information about the communication devices classified into a plurality of managing groups, and uses the state information associated with the communication device information to update the latter information on a managing group-by-group basis by a data updater 38, thereby making it possible to accurately and easily manage the connecting communication device information for use in processing signals coming from the connecting communication devices.

The signal processing unit 12 manages, on the station data managing table of the station data memory 40, information including various numbers and signal processing conditions about the connecting communication devices in correspondence with the state information on the state of the connecting communication devices, and also manages the information about the communication devices classified into the plurality of managing groups, and further uses the state information associated with the communication device information to update the latter information on a managing group-by-group basis by the data updater 38, and still further uses by a signal processor 24 information managed on the station data managing table 46 to process signals received from the connecting communication devices, thereby making it possible to more accurately and easily manage the connecting communication device information.

With the illustrative embodiment of the invention, a program is provided which controls, when installed and executed on a computer, the computer to function as the aforementioned components of the data manager 28 and the signal processing unit 12 to process the received signals, thus facilitating a more accurate and easy management of the connecting communication device information.

Elements not directly relevant to understanding the present invention will not specifically be shown and described. Signals and data will be designated with reference numerals for connecting lines on which they appear.

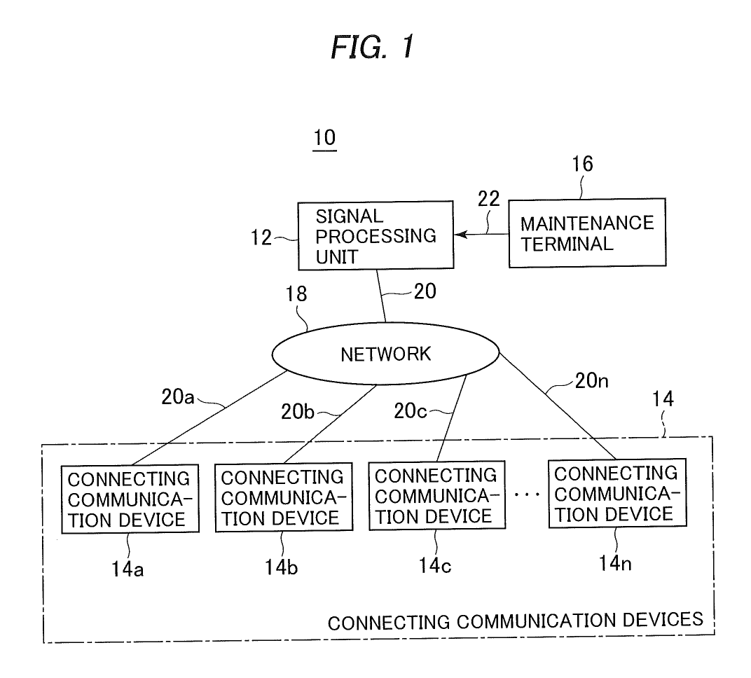

FIG. 1 shows a general configuration of a telecommunications network system 10 provided with a signal processing apparatus in accordance with the embodiment. The telecommunications network system 10 comprises a signal processing unit 12, a plurality of connecting communication devices 14a-14n and a maintenance terminal device 16. For an illustration purpose, the plurality of connecting communication devices 14a-14n may form a group 14, which may be referred to as a connecting communication device group. The connecting communication devices 14a-14n may include terminal devices, communication devices and the like subscribers may use. The signal processing unit 12 and the connecting communication devices 14a-14n may communicate with each other over a telecommunications network 18, which may be an IP (Internet Protocol) network.

The signal processing apparatus 12 has a function to manage station data or information. The signal processing unit 12 may be, for example, a call processor or controller of a telecommunications carrier. More specifically or advantageously, the signal processing unit 12 may be a SIP (Session Initiation Protocol) server which is adapted to control signaling for providing the connecting communication devices 14a-14n with communication services by means using SIP messages or signals. In such a case, the signal processing unit 12 may be adapted to perform a call control such as to, for example, transmit and receive SIP signals between one connecting communication device originating a call of voice communication and another connecting communication device on which the call is terminated to thereby allow a media communication, i.e. to thereby establish a voice call connection, between both connecting communication devices.

The connecting communication device group 14 comprises the plurality (N) of connecting communication devices 14a, 14b, 14c, . . . , 14n, which are connected to the network 18, where N is a natural number. Therefore, to the network 18 there are connected the signal processing unit 12 and the connecting communication devices 14a, 14b, 14c, . . . , 14n by respective signal lines 20, 20a, 20b, . . . , 20n. In the instant preferred embodiment, the respective connecting communication devices 14a, 14b, 14c, . . . , 14n may be communication terminals compatible with the SIP. Specifically, those devices may be terminal devices adapted for using the SIP to perform media communication, such as message transmission and reception, and voice and video calls. To the connecting communication group 14, any existing terminal devices compatible with the SIP are applicable, and thus, more detailed description thereon will be avoided.

The signal processing unit 12 has the capability of processing SIP signals under several conditions, and processes, when communicating with a connecting communication device 14m, the SIP signals under a signal processing condition compatible with that connecting communication device, where m is any of the letters a, b, c, . . . , n. Further, the signal processing unit 12 has the function for managing administrative information about the connecting communication devices, including signal processing conditions for the respective connecting communication devices 14a, 14b, 14c, . . . , 14n, as station data.

The maintenance terminal device 16 is an interfacing unit for use in managing data of the signal processing unit 12 by the operator when conducting the maintenance or service of the communication system 10. In the instant preferred embodiment, the signal processing unit 12 is adapted for receiving operator signals 22 produced by the maintenance terminal device 16 in response to an operator's manipulation. The maintenance terminal device 16 may be, for example, a terminal unit used as a console for maintenance and service operation, such as an existing personal computer or the like.

The internal configuration of the signal processing unit 12 will be described with reference again to FIG. 2. The signal processing unit 12 comprises a signal processor 24, a signal transmitter/receiver 26 and a data manager 28, which are interconnected as depicted.

The signal processor 24 may be implemented by a processor system, such as a computer comprising a CPU (Center Processing Unit), ROM (Read-Only Memory), RAM (Random Access Memory), EEPROM (Electrically-Erasable Programmable Read-Only Memory), a hard disc drive and the like, as well as an interface for communicating with other communication devices. Such a processor system may, for example, have data managing and signal processing program sequences installed to be executed in accordance with the preferred embodiment. The data managing program sequences may configure the data manager 26 while the signal processing program sequences may function as processing signals in response to information or signals controlled by the data manager 26 in the signal processing unit 12.

The signal processing unit 12 configured as such may be represented as schematically shown in FIG. 2. In the signal processing unit 12, part for executing the data managing program sequences and part for executing the signal processing program sequences may be physically separate in hardware from each other, or alternatively may be common in hardware to each other. In other words, the signal processing unit 12 may not be limitative in respect of how to separate resources, such as hardware, for executing the data managing and signal processing program sequences. In this connection, the word “circuit”, “device” or “unit” may be understood not only as hardware, such as an electronics circuit, but also as a function that may be implemented by software installed and executed on a computer.

In the signal processing unit 12, the transmitter/receiver 26 bears an interface function for connecting to the network 18. The signal processing unit 12 transmits and receives a packet signal 20, such as an SIP signal or the like. The transmitter/receiver 26 feeds the received signal 30 to the signal processor 24. The transmitter/receiver 24 sends the packet signal 32 fed from the signal processor 24 toward the destination of that signal.

The signal processor 24 has a communication control function for transmitting and receiving the SIP signals 30 and 32 to and from the respective connecting communication devices 14a, 14b, 14c, . . . , 14n through the transmitter/receiver 26 so as to provide the respective connecting communication devices 14a, 14b, 14c, . . . , 14n with communication services. Further, the signal processor 24 feeds access control signals 34 and 36 to the data manager 28 to thereby reference station data or the like managed by the data manager 28, and then reads out appropriate information to confirm the signal processing conditions of the respective connecting communication devices 14a, 14b, 14c, . . . , 14n, thus communicating with the connecting communication devices by means of SIP signals compatible with the confirmed signal processing conditions.

The internal configuration of the data manger 26 will be described. The data manager 26 comprises a data updater 38, a station data memory 40 and an identification memory 42, which are interconnected as illustrated.

The date updater 38 has the function for updating respective data stored in the station data memory 40 and the identification memory 42. In the present preferred embodiment, the data updater 38 is responsive to an operator's manipulation on the maintenance terminal device 16 to feed an updating control signal 44 to the station data memory 40 and the identification memory 42 to thereby update the stored data.

The station data memory 40 in the data manager 28 has the function for storing station data. In the present preferred embodiment, the station data memory 40 includes a station data managing table 46 in which the station data including information about the respective connecting communication devices 14a, 14b, 14c, . . . , 14n are stored. The station data memory 40 may be a rewritable storage medium.

The identification memory 42 has an identification managing table 48 stored, according to which identifications are managed which are associated with signals including test parameters for use in a test in communication with the connecting communication devices 14a, 14b, . . . , 14n of the communication system 10 in the test mode thereof. The identification memory 42 may also be a rewritable storage medium. Those memory or storage media may not be separate in hardware from each other but may be sufficient if definite in storage areas in a memory device.

In addition, the data manager 26 may not be limited in configuration by how to accept manipulation from the operator. For example, the data manager 26 in itself may include an input/output device as a user interface, such as a display unit, a keyboard or the like, so as to receive direct manipulation of the operator.

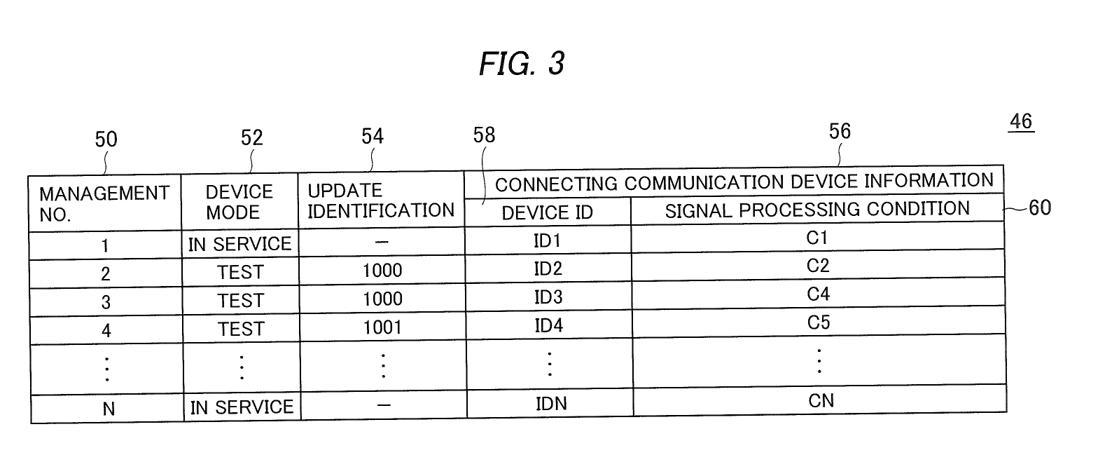

An example of the content of the station data managing table 46 will be shown in FIG. 3. On the station data managing table 46, each line or record includes data or information about one connecting communication device defined with the entries in the four columns or fields. The four fields may be a management number 50, device mode 52, update identification 54 and connecting communication device information 56 with the illustrative embodiment.

The management number field 50 contains a number, e.g. serial number, allotted to a particular connecting communication device for specifying a line of the station data managing table 46 containing information on that particular connecting communication device. The management numbers 50 are allotted to the connecting communication devices 14a, 14b, 14c, . . . , 14n, respectively with numbers 1 to N. Of course, other codes than numbers may be applied.

The device mode field 52 contains information or data on the operational state, or mode, of the connecting communication devices. In the present preferred embodiment, the device mode field 52 defines a particular connecting communication device which is either “under testing”, i.e. in its “test mode” not yet in service, or “in service” available with user service or so.

On the station data managing table 46, whenever a connecting communication device is currently tested, or in its test mode, “test” is indicated in the field 52 of that device. Whenever a connecting communication device is in service, “in service” is indicated in the field 52 of that device. In other words, in the embodiment, the device mode field 52 is filled with either one of the two modes, “test” or “in service”, although it may further be fragmented for management.

The mode “test” may be fragmented into, for example, a sub-mode “under testing” in which a connecting communication device has its test not yet completed, and a sub-mode “ready for service” in which a connecting communication device has its test completed to be on standby.

The update identifications 54 specify, on the station data managing table 46, the connecting communication devices being in the test mode thereof classified into several groups. In other words, the update identifications function as identifying groups to which particular connecting communication devices belong. For example, on the table 46, the update identifications on the records of the management numbers “2” and “3” are indicated as “1000”, which means that the connecting communication devices 14b and 14c corresponding to the management numbers “2” and “3”, respectively, belong to the same group. A group containing one or more connecting communication devices specified in this way with the same update identification may be referred to as an “update group”. The data manager 28 is adapted to manage the connecting communication devices in such a fashion that connecting communication devices belonging to the same update group may be shifted from the test mode to the operation, i.e. in-service, mode thereof at the same timing, i.e. in a batch. Thus, the data manager 28 allows, under the control of the data updater 38, shift to the in-service mode on an update group-by-group basis in a batch.

In addition, since the fields 54 of update identification may be filled with the identifications of connecting communication devices when they are in the test mode thereof, they are rendered blank, indicated with “-”, whenever connecting communication devices are in the operation mode thereof, i.e. in service.

The connecting communication device information field 56 contains information to be used when the signal processor 24 processes signals in connection with particular connecting communication devices. The connecting communication device information filed 56 may include subfields “device ID (IDentification)” 58 and “information on signal processing condition” 60. The subfield “information on signal processing condition” 60 may further include other information.

The subfield “device ID” 58 may include the identifications (IDs) of the connecting communication devices. The connecting communication devices 14a, 14b, 14c, . . . , 14n have the respective device IDs specifically set to ID1 to IDN.

Merely for simplicity, the device ID may simply be expressed by IDx, where the variable x is a natural number not exceeding N. In practice, the device identifications may be any types of identifications specifying the connecting communication devices on the network, such as IP addresses, telephone numbers, which are identifications on the SIP, identification numbers or codes, or the like.

The field “information on signal processing condition” 60 defines conditions under which communication is to be made with the connecting communication devices, e.g. SIP signal conditions. The content of the information on signal processing condition field 60 is represented by symbols C1 to CN just for simplicity in the illustrative embodiment. In practice, however, data defining specific signal processing conditions may be input therein.

The field 60, however, may not contain conditions for signal processing in the form of data, but in the form of URL (Uniform Resource Locator) input in the table for linking to e.g. a Web site providing information on a specific signal processing condition or conditions.

In this way, on the station data managing table 46, the connecting communication device information 56 about the respective connecting communication devices is managed in connection with the device mode 52.

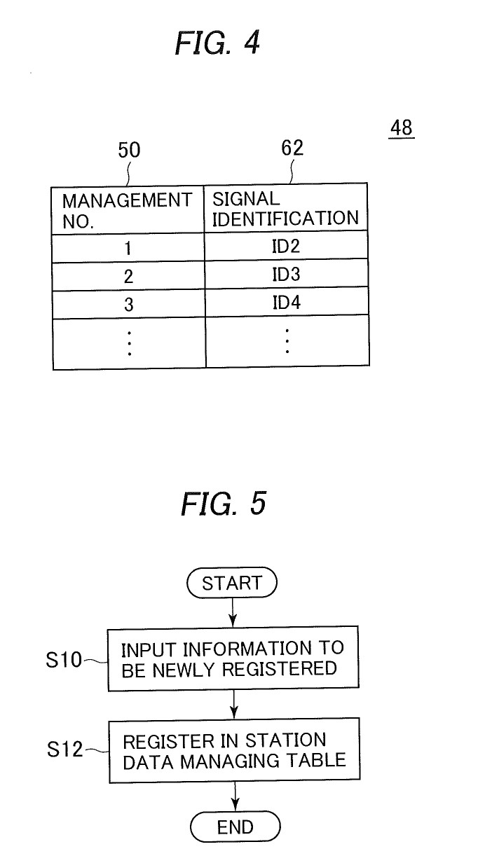

With reference to FIG. 4, an example of the content of the identification managing table 48 will be described. The identification managing table 48 is adapted to manage the signal identification 62 in correspondence with the management numbers. The “management numbers” 50 are information specifying and managing the signal identifications 62, and may correspond to the management numbers 50 on the station data managing table 46.

The signal identification field 62 may contain, for example, an identification of test signals applied to testing a connecting communication device. More specifically, the signal identifications 62 may be the telephone numbers of connecting communication devices under testing. In other words, such a telephone number may be an identification specifying a particular connection communication device on the SIP. In the field “device ID” of the station data managing table 46, the telephone numbers of the connecting communication devices 14a, 14b, 14c, . . . , 14n may also be used, like in the field of signal identifications 62 on the identification managing table 48.

The signal processor 24 is adapted to consult, when signals are received from the connecting communication devices 14a, 14b, 14c, . . . , 14n, with the identification managing table 48 to determine whether the signals received are test signals sent for test or signals sent actually in service, i.e. under communication services. For example, when the signal processor 24 receives signals from the connecting communication devices 14a, 14b, 14c, . . . , 14n, it determines whether or not the received signals carry a parameter registered as a signal identification 62 on the identification managing table 46. Whenever the signals contain a parameter registered as a signal identification, they will be determined as test signals by the signal processor 24.

More specifically, when the signal processor 24 detects that a specific field, such as a field specifying a transmitter (FROM) or destination (TO), of the header of a SIP signal, such as an INVITE message, received from one of the connecting communication devices 14a, 14b, 14c, . . . , 14n contains a telephone number on the SIP registered as a signal identification on the identification managing table 48 for the signals to be tested, the processor 24 determines the SIP signals as test signals. Whenever the signal processor 24 has determined the SIP signals as being test signals, it will process them according to an appropriate testing scenario. For example, the signal processor 24 is responsive to the test signals to proceed to testing only on such connecting communication devices that have the device mode 52 thereof denoted with “test” in the field of connecting communication device information 56 registered on the station data managing table 46.

When the signal processor 24 receives signals received while being in service, i.e. signals not being test signals, it proceeds according to an in-service scenario. For example, the signal processor 24 may be responsive to signals received while being in service to proceed only to connecting communication devices associated with the device mode 52 denoted with “in service” in the connecting communication device information field 56 registered on the station data managing table 46.

The operation of the signal processing unit 12 in the telecommunications network system 10 in accordance with the preferred embodiment will be described. At first, with reference to a flowchart shown in FIG. 5, the procedure will be described for registering a new record in the station data managing table 46 by means of the data updater 38 of the data manager 28. In the station data managing table 46, the record of the station data in a line may be collectively referred to as “connecting device managing information”.

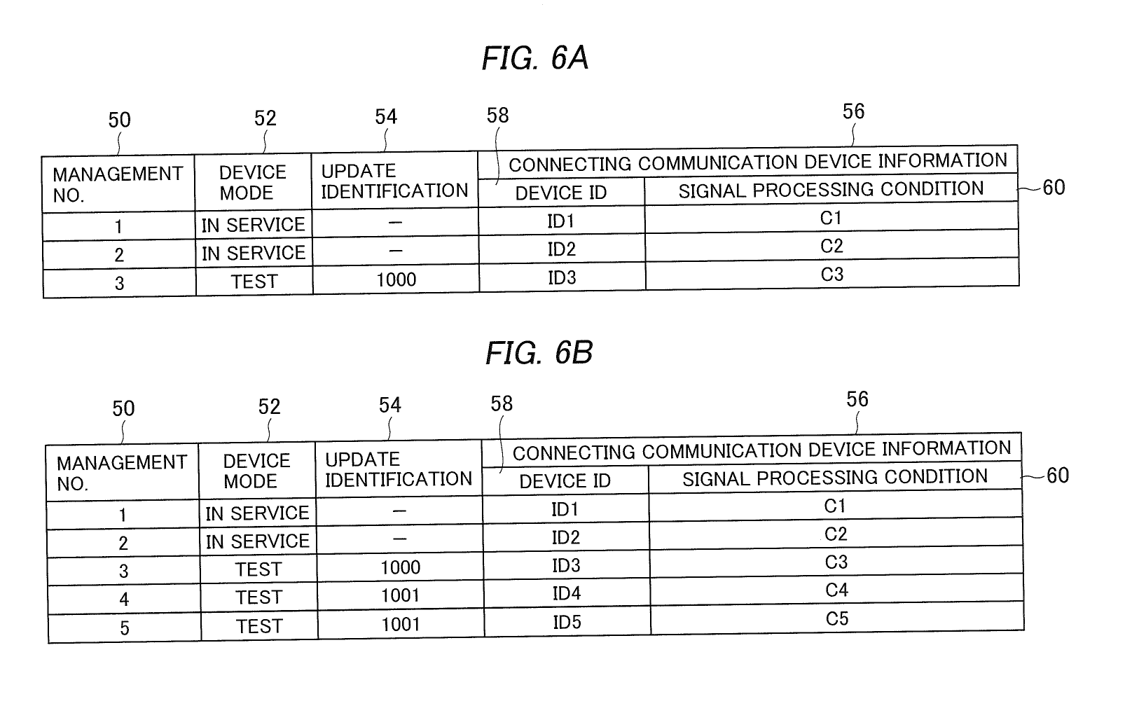

Now, in the station data managing table 46 shown in FIG. 6A, there is registered information only about the connecting communication devices 14a, 14b and 14c that are in the initial state thereof, i.e. device identifications ID1, ID2 and ID3, respectively. The connecting communication devices 14a and 14b are in service, while the connecting communication device 14c is in its test mode.

In the telecommunications network system 10, information to be newly registered is input (step S10). Specifically, the operator operates the maintenance terminal device 16, which in turn produces information about the connecting communication devices 14d and 14e having their identifications ID4 and ID5, respectively. The maintenance terminal device 16 feeds the produced data 22 to the data updater 38 in the data manager 28.

Subsequently, the data 44 are registered in the station data managing table 46 (step S12). The data updater 38 supplies the fed data 44 to the station data managing table 46 and writes the data thereinto as additional data. In the writing process, new data are recorded.

As the result of registration by the data updater 38, the station data managing table 46 has the content shown in FIG. 6B. Compared to the state shown in FIG. 6A, it can be seen that FIG. 6B has the records of connecting device managing information added which correspond to the device identifications ID4 and ID5 about the connecting communication devices 14d and 14e, respectively.

The added connecting device managing data shown in FIG. 6B include an update identification “1001”. Further, the added connecting device managing information contains “test” in the field of device mode 54 on both records.

In the data updater 38, it may not be restrictive how to receive input data of the connecting communication devices to be newly registered from the maintenance terminal device 16. The data updater 38 may be adapted to receive input data in the form of, for example, text data, such as CSV (Comma-Separated Values), where parameter values are separated with commas, spaces or the like, or of spreadsheet data.

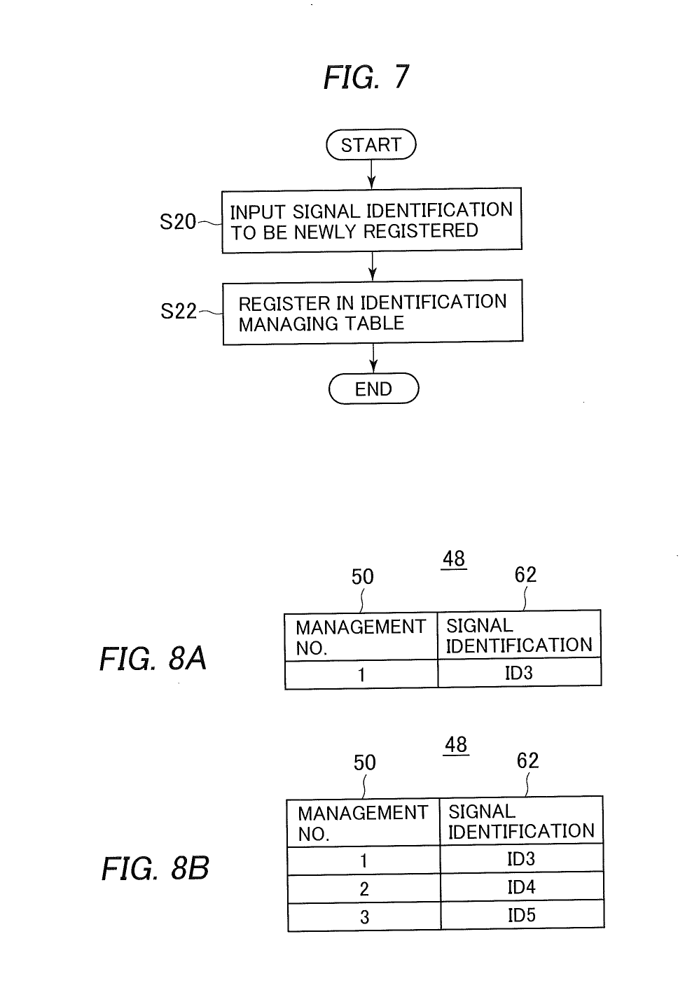

The procedure for registering a new record in the identification managing table 48 by means of the data updater 38 of the data manager 28 will be described with reference to FIG. 7. In the identification managing table 48 shown in FIG. 8A there are registered only data of the connecting communication device 14c being in its starting state, i.e. of the device identification ID3.

In the communication system 10, a list of signal identifications to be newly registered is input (step S20). Specifically, the operator operates the maintenance terminal device 16 to produce a list of signal identifications ID4 and ID5 about the connecting communication devices 14d and 14e. The maintenance terminal device 16 feeds the produced identification data 22 to the data updater 38 in the data manager 28.

Then, the identification data 44 are registered in the identification managing table 48 (step S22). The data updater 38 supplies the fed identification data 44 to the identification managing table 48 and writes the data thereinto as additional data. In the writing process, new data are registered.

As the result of registration by the data updater 38, the identification managing table 48 has the content shown in FIG. 8B. Compared to the state shown in FIG. 8A, it can be seen that FIG. 8B has the records of connecting device managing information added which correspond to the device identifications ID4 and ID5 about the connecting communication devices 14d and 14e, respectively. Thus, it can be seen that the identification managing table 48 for signals to be tested shown in FIG. 8B is in conformity in content with the station data managing table 46 shown in FIG. 6B.

In the data updater 38 also, it may not be restrictive how to receive input data for the connecting communication devices to be newly registered from the maintenance terminal device 16. For example, such input data may be entered in a manner similar to that of the aforementioned station data managing table 46.

In summary, in the data manager 28, when data related to the connecting communication devices in the test mode thereof are newly added to the station data managing table 46, the identifications of the test signals associated with those connecting communication devices have to be registered in the identification managing table 48. In the instant preferred embodiment, new records of the connecting device managing information are registered by the operator in the station data managing table 46 separately from signal identifications being registered in the identification managing table 48 for signals to be tested. Alternatively, the data updater 38 may be adapted to receive added data to be newly registered in the station data managing table 46 and signal identifications in correspondence with the added data in question for associative management. In such a case, for example, on the identification data managing table 48 for signals to be tested, the management numbers on the station data managing table 46 may be managed together in correspondence with the respective signal identifications. The management number in the context is the management number of a connecting communication device corresponding to the signal identification in question.

In an application of the telecommunications network system 10 in which the signal identifications are defined as device IDs such that a signal identification included in the connecting device managing information corresponds to a connecting communication device associated therewith, the data updater 38 may receive the connecting device managing information to be newly registered from the maintenance terminal device 16, when operated by the operator, and extract a device ID from the received connecting device managing information to then newly register the extracted device ID as an identification in the identification managing table 48 for signals to be tested.

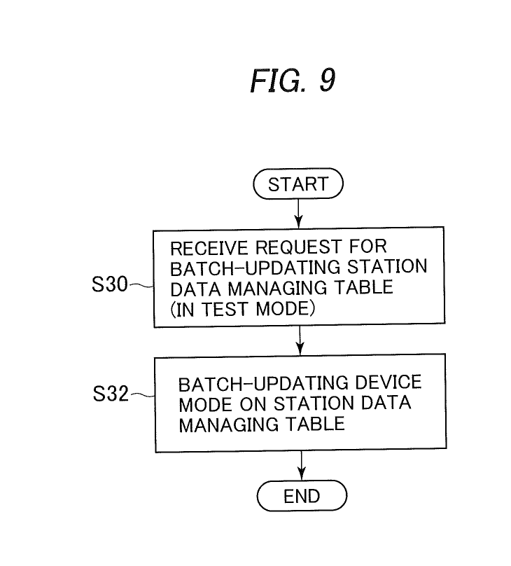

The operational procedure for batch-updating by the data updater 38 in the data manager 28 by means of the update identifications will be described with reference to a flowchart shown in FIG. 9.

At first, the operator manipulates the maintenance terminal device 16 to input, for example, a request command and data required for batch-updating the device state data in the station data managing table 46 by means of the update identifications into the data updater 38 of the data manager 28 (step S30). The batch-updating in the instant preferred embodiment means, for example, updating the device mode 52 at a time according to the values of the update identifications. The maintenance terminal device 16 produces not only a request command but also an update identification as well as information to be updated and a set of values thereof in the form of batch data 22. The maintenance terminal device 16 feeds the generated batch data 22 to the data updater 38.

The data updater 38 is in response to the batch data 44 that are input from the maintenance terminal device 16 as an update command to update the content of the station data managing table 46 (step S32).

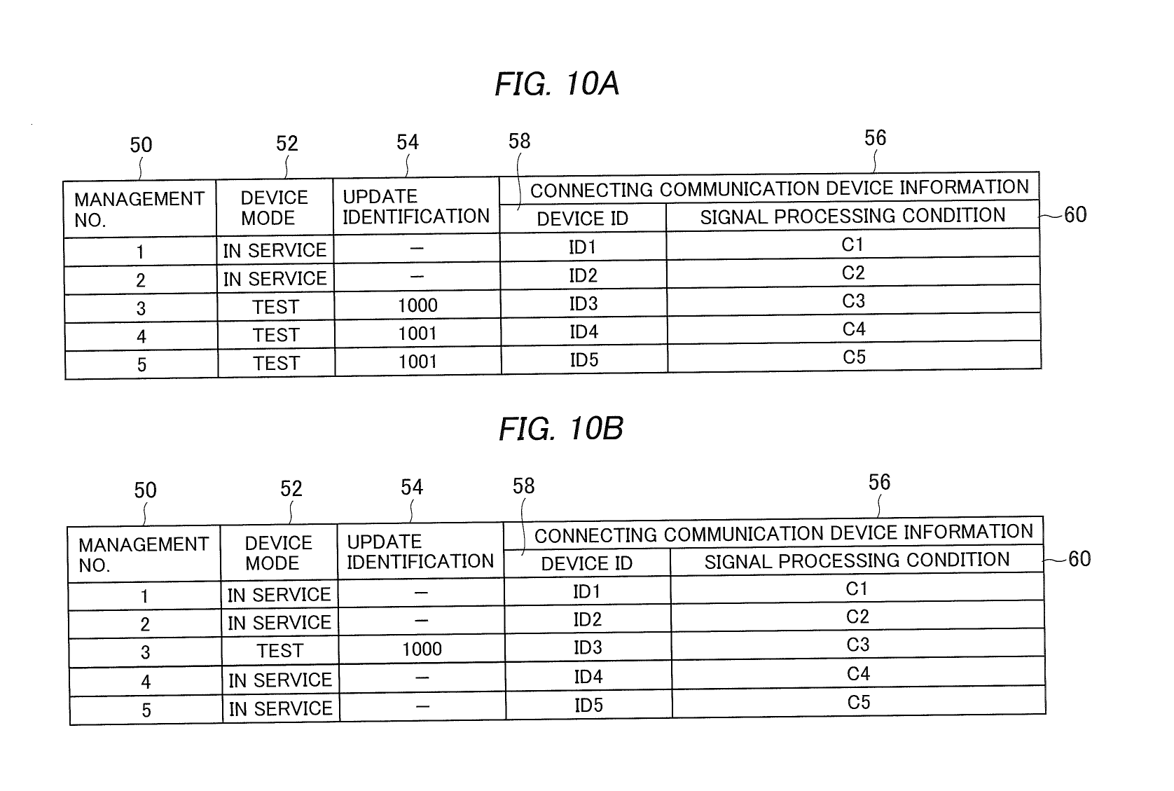

As a specific example, in the station data managing table 46 shown in FIG. 10A, the state after the registration will be written in as its starting state. On the maintenance terminal device 16, the operator inputs a command for updating all the device mode 52 for the connecting communication devices assigned with a value “1001” for the update identification 54 from “test” to “in service”.

The data updater 38 is responsive to the command on the maintenance terminal device 16 to update all the device mode 52 on the station data managing table 46 for the connecting communication devices assigned with the value “1001” of the update identification 54 from “test” to “in service”. As the result, the station data managing table 46 will be what is shown in FIG. 10B. On the station data managing table 46 shown in FIG. 10B, data of the device mode 52 are updated from “test” to “in service” for the connecting communication devices 14d and 14e assigned with the value “1001” of the update identifications ID4 and ID5. At this instance, the data of the device mode 52 are updated to “in service”, so that the update identifications 54 appropriate in the records of connecting device managing information are updated to blank represented by “-”.

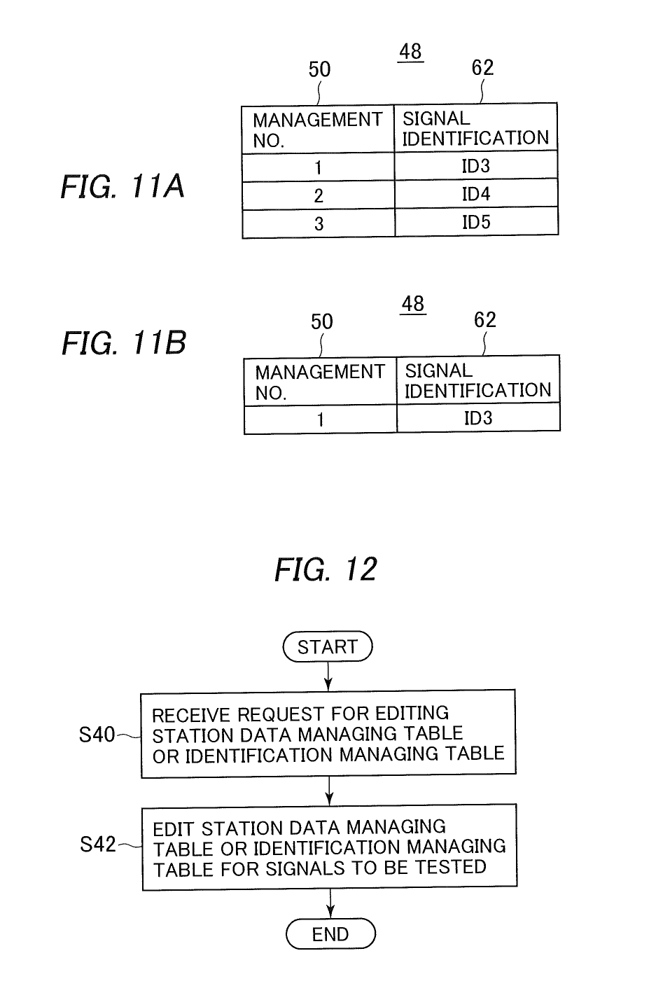

Further, at this instance, the data updater 38 may delete from signals to be tested in the identification managing table 48 identifications associated with the connecting communication devices 14d and 14e having the data of the device mode field 52 updated from “test” to “in service”. On the identification managing table 48, it is assumed for example that, starting from the state where the registration has been completed as shown in FIG. 11A for the connecting communication devices 14d and 14e corresponding to the device identifications ID4 and ID5, respectively, the data of the device mode field 52 are updated from “test” to “in service”. For the connecting communication devices 14d and 14e having the data of the device mode field 52 thus updated from “test” to “in service”, the data updater 38 may delete the signal identifications ID4 and ID5 from the signal identification field 62 to thereby update the station data managing table 48 to the state shown in FIG. 11B.

It may not be limitative how the station data managing table 48 receives the batch-updating based on the update identifications 54 from the maintenance terminal device 16. For example, a Web browser may be used to manipulate a GUI (Graphical User Interface) screen to enter commands on the display. Alternatively, an update command may be entered in the form of command statements of a predetermined format.

In short, the data manager 28 thus uses the update identifications 54 as keys in order to shift the states to “in service” in a batch on an updating group-by-group basis. The shift of the data of the device mode field 52 from “test” to “in service” is usually rendered for such connecting communication devices that were successfully tested and matured into the serviceable condition thereof.

By contrast, for such connecting communication devices that were revealed defective through the test, the operator may correct the content of the station data managing table 46. For example, he or she may debug the information record on the signal processing condition field 60.

Description will be made on the operational procedure for editing the station data managing table 46 or the identification managing table 48 for signals to be tested, by means of the data updater 38 in the data manager 28, with reference to a flowchart shown in FIG. 12. Operator's manipulation on the maintenance terminal device 16 causes the data updater 38 of the data manager 28 to receive an edit command for the station data managing table 46 or the identification managing table 48 (step S40).

The data updater 38 receives the edit command from the maintenance terminal device 16 to edit the content of the station data managing table 46 or the identification managing table 48 accordingly (step S42).

It may not be limitative how the data updater 38 receives an edit command from the maintenance terminal device 16. For example, a Web browser may be used to conduct a GUI operation thereon to receive edit commands for the respective tables 46 and 48. Alternatively, edit instructions may be formulated into database operation commands of a predetermined format of an SQL (Structure Query Language) statement. Further, the data updater 38 may be responsive to the edit commands to delete data of the station data managing table 46 or the identification managing table 48, i.e. line records of data on those tables.

Moreover, the data updater 38 may be so arranged that the connecting device management information having the device mode 52 denoted with “test” is allowed to be batch-edited with the update identifications 54 designated. For example, the data updater 38 may be adapted such that, when information associated with the update identifications 54 designated by operator's manipulation on the maintenance terminal device 16 may be batch-deleted or have the same content thereaccross, the information on signal processing condition 60 may be changeable.

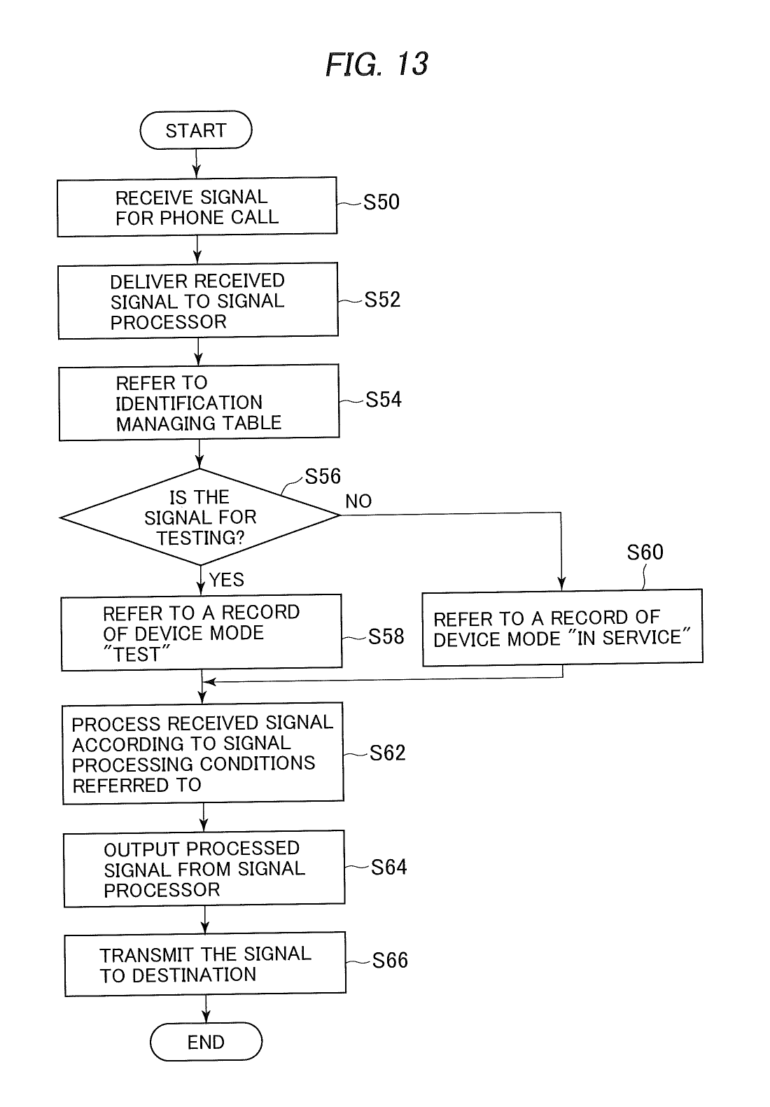

Now, with reference to a flowchart shown in FIG. 13, the operational procedure will be described in the case when the signal processor 24 of the signal processing unit 12 receives signals from the connecting communication devices 14a, 14b, 14c, . . . , 14n. In the preferred embodiment, the signal processing unit 12 will operate as described below when INVITE messages, which are a kind of SIP signals, are received from the connecting communication devices 14a, 14b, 14c, . . . , 14n.

The signal transmitter/receiver 26 receives SIP signals from the connecting communication devices 14a, 14b, 14c, . . . , 14n (step S50). The signal transmitter/receiver 26 delivers the received SIP signals 30 to the signal processor 24 (step S52).

When the signal processor 24 is fed with the SIP signals, it refers to the data of the identification managing table 48 (step S54). The signal processor 24 accesses the identification memory 42 of the data manager 28 to acquire an appropriate signal identification 62 of the identification managing table 48 in the identification memory 42. The signal identifications 62 are, as previously described, information applied in a test for the connecting communication devices.

The identification managing table 48 is thus referenced to check whether or not the SIP signals are test signals (step S56). If the signal processor 24 obtains appropriate signal identifications 62 through the reference to the table 48, it confirms they are test signals. In this case (YES), the procedure proceeds to the step S58 of referencing the records of the “test” mode on the station data managing table 46. When the signal processor 24 fails to obtain an appropriate signal identification 62 through the referencing (NO), it determines as servicing a phone call to proceed to the step S60 of referencing the records of the “in-service” mode on the station data managing table 46.

When the decision result from the step 56 is positive, the signal processor 24 refers on the station data managing table 46 to the connecting device managing information having the device mode 52 denoted with “test” (step S58). When the decision at the step 56 is negative, the signal processor 24 refers on the station data managing table 46 to the connecting device managing information having the device mode 52 denoted with “in service” (step S60).

Thereafter, the signal processor 24 processes the SIP signals based on the connecting device managing information thus referred to (step S62). The SIP signals are processed according to the signal processing condition of the connecting device managing information.

The signal processor 24 produces signals according to the signal processing condition thus referred to to deliver them to the signal transmitter/receiver 26 (step S64). The signal transmitter/receiver 26 transmits the SIP signals delivered from the signal processor 24 toward the destinations of the SIP signals, namely to destinations on which the phone calls are to be terminated (step S66).

In accordance with the preferred embodiment, the data manager 28 can update, in the updating process of the station data managing table 46, the device mode 52 about a plurality of connecting communication devices in a batch from the test mode to the in-service mode thereof on a managing group-by-group basis based on the update identifications 64.

In the example shown in FIG. 6B, the connecting communication devices 14d and 14e having the value “1001” of the update identifications 54 are dealt with in the same updating group, while the connecting communication device 14c is classified into another update group having the different value “1000” of the update identification 54. Accordingly, even when the connecting communication devices 14c, 14d and 14e are tested in the same period of time, such as on the DD-th day of a month MM in a year YYYY, but brought into service at different times updating-group by group, it is possible to manage the shift from a test mode to an in-service mode on an updating group-by-group basis. It is facilitated to arrange the system, in which, for example, only the connecting communication devices 14d and 14e are to be shifted to the in-service mode on the same day of March in the year YYYY while excluding the remaining connecting communication device 14c by rendering the latter to a different updating group.

As described above, the signal processing unit 12 manages the connecting communication devices in the test mode thereof on a group-by-group basis. Therefore, even when the connecting communication devices are to be shifted into service at different times, various kinds of information can be efficiently managed, thus improving maintenance performance of the system.

Further, the signal processing unit 12 uses the identification managing table 48 to determine whether or not the received signal is a test signal. This makes it easier for the signal processing unit 12 to process a test signal and an operational or in-service signal separately from each other even in an environment including connecting communication devices that are in the test and in-service modes.

The present invention may not be confined to the foregoing preferred embodiment, but other alternative embodiments may be accomplished, which will be described below.

In the foregoing preferred embodiment, the data manager 28 is provided on the signal processing unit 12. However, it may not be limitative where the data manager is placed. For example, the data manager 28 may be placed outside the signal processing unit 12 and connected thereto through signal transmission.

With the foregoing illustrative embodiment, the communication system 10 includes the single signal processing unit 12. However, plural signal processing units like the unit 12 may be placed in the system 10. In the latter case, such plural signal processing units 12 may receive information from the sole data manager 28. In this way, the signal processing unit 12 and the data manager 28 thus separated in physical unit from each other make the station data more efficiently managed on the station data managing table 46.

In the preferred embodiment described so far, the data manager 28 manages information in the form of tables. It may not be restrictive how to manage those data. For example, data may be managed on a database.

In the foregoing preferred embodiment, the data manager 38 performs registering and editing, such as updating or deleting, information on the tables in response to manual operation by the operator on the maintenance terminal device 16. Such editing may be made at the time and according to the content the operator sets in advance.

In the signal processing unit 12 of the foregoing embodiment, the correspondence relationship is fixed in advance between the respective signal identifications 62 and the respective connecting communication devices. The signal processor 24 may be adapted to hold in advance testing scenarios planned on an update identification-by-identification basis 54 so that a signal identification 54 is detected from a received signal to determine the update identification 54 of a connecting communication device associated with the detected signal identification 62, and then, a testing scenario appropriate for the determined update identification 54 is used to process the signal in question.

The entire disclosure of Japanese patent application No. 2011-262259 filed on Nov. 30, 2011, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A data manager for managing information for use in processing a signal by a signal processing apparatus for processing signals received from communication devices, said data manager comprising:
a first information memory managing communication device information including numbers and signal processing conditions about the communication devices in correspondence with state information on a state of the communication devices with the communication device information classified into a plurality of managing groups; and
a data updater updating the state information associated with the communication device information on a managing group-by-group basis.

2. The data manager in accordance with claim 1, wherein the state information represents whether or not the communication device is in a test mode.

3. The data manager in accordance with claim 1, further comprising a second information memory managing, for ones of the respective communication devices managed as being in a test mode in said first information memory, a test signal identification specifying a test signal for use in testing the communication devices.

4. A signal processing apparatus for processing signals received from communication devices, said apparatus comprising:
a first information memory managing communication device information including numbers and signal processing conditions about the communication devices in correspondence with state information on a state of the communication devices with the communication device information classified into a plurality of managing groups;
a data updater updating the state information associated with the communication device information on a managing group-by-group basis; and
a signal processor using information managed in said first information memory to process signals received from the communication devices.

5. The apparatus in accordance with claim 4, further comprising a second information memory managing, for ones of the communication devices managed as being in a test mode in said first information memory, a test signal identification specifying a test signal for use in testing the communication devices,
said signal processor comparing the test signal identification managed in said second memory with a content of signals received from the communication devices to thereby determine whether or not the signals are the test signals,
said signal processor processing the received signals determined as being test signals as test signals.

6. A computer-readable recording medium having a data managing program recorded which controls a computer installed in a data manager for managing information for use in processing a signal by a signal processing apparatus for processing signals received from communication devices, said program controlling the computer to function as:
managing, in a first information memory, communication device information including numbers and signal processing conditions about the communication devices in correspondence with state information on a state of the communication devices with the communication device information classified into a plurality of management groups; and
a data updater updating the state information associated with the communication device information on a managing group-by-group basis.

7. The recording medium in accordance with claim 6, wherein said program controls the computer to function as using a second information memory to manage, for ones of the communication devices managed as being in a test mode in the first information memory, a test signal identification specifying a test signal for use in testing the communication devices.

8. A computer-readable recording medium having a signal processing program recorded which controls a computer installed in a signal processing apparatus for processing signals received from communication devices, said program controlling the computer to function as:
managing, in a first information memory, communication device information including numbers and signal processing conditions about the communication devices in correspondence with state information on a state of the communication devices with the communication devices classified into a plurality of managing groups;
a data updater updating the state information associated with the communication device information on a managing group-by-group basis; and
a signal processor using information managed in the first information memory to process signals received from the communication devices.

9. The recording medium in accordance with claim 8, wherein said program controls the computer to function as:
using a second information memory to manage, for ones of the communication devices managed as being in a test mode in the first information memory, a test signal identification specifying a test signal for use in testing the communication devices;
comparing the test signal identification managed in the second memory with a content of signals received from the communication devices to thereby determine whether or not the signals are the test signals; and
processing the received signals determined as being test signals as test signals.
